(19) United States
(12) Patent Application Publication
(10) Pub. No.: US 2013/0031548 A1
(43) Pub. Date: Jan. 31, 2013

(54) INFORMATION PROCESSING APPARATUS AND STORAGE MEDIUM

(71) Applicant: Tatsuya Kurozumi, Hachioji-shi (JP)

(72) Inventor: Tatsuya Kurozumi, Hachioji-shi (JP)

(21) Appl. No.: 13/416,278

(22) Filed: Mar. 9, 2012

(30) Foreign Application Priority Data
Jul. 29, 2011 (JP) 2011-167510

(51) Int. Cl. G06F 9/455

(52) U.S. Cl. 718/1

(57) ABSTRACT

According to one embodiment, an information processing apparatus includes a virtual disk management module which manages a first virtual disk, a second virtual disk and a third virtual disk. The first virtual disk is a disk in which disk image data from a disk with various programs installed therein is stored. The second virtual disk is a disk in which the disk image data of the first virtual disk and from which individual information retained by the various programs has been deleted is stored. The third virtual disk is a disk in which the disk image data of the second virtual disk and to which individual information to be retained by the various programs has been added is stored.

### CROSS-REFERENCE TO RELATED APPLICATIONS

This application is based upon and claims the benefit of priority from prior Japanese Patent Application No. 2011-167510, filed Jul. 29, 2011, the entire contents of which are incorporated herein by reference.

### FIELD

Embodiments described herein relate generally to an information processing apparatus applied to a network system in which a server manages software environments for a plurality of clients in a unified manner.

### BACKGROUND

In recent years, many companies have based their businesses on IT (Information Technology). In such companies, employees use PCs (Personal Computers) lent by the company to perform operations. Furthermore, LANs (Local Area Networks) are widely laid in offices in order to interconnect the PCs to share resources including data.

On the other hand, disadvantageously, confidential information on companies may often leak via PCs used for operations by employees. Thus, there has been a strong demand to enhance security for PCs used for operations in the offices.

For example, a thin client is a computer comprising, besides a CPU (Central Processing Unit) and a main memory, only a communication device as well as a keyboard and a display device each serving as a user interface. Various programs and data are managed by a server (thin-client server) connected to the client via a network. That is, no data is saved to the thin client, which is used by users. This enables information to be prevented from leaking, allowing security to be enhanced. Furthermore, programs available on the thin client are limited to those which are managed by the server. Hence, the computer can be prevented from being used for unintended purposes (purposes other than the businesses). As a scheme in which the programs used by the user are managed by the server, a rich client platform is also applicable.

Several implementation schemes are available for the thin client. One of the schemes will be described by way of example. A thin-client server constructs a plurality of virtual machines which are created by software and which are virtual hardware environments allowing various programs including an operating system to operate. The thin-client server then assigns a thin client to each of the virtual machines. Then, the thin-client server transmits display image data for a display screen created by the various programs including the operating system and operating on each of the virtual machines, to the corresponding thin client. Thus, on the thin client side, the display screen is presented to a user. Furthermore, the thin-client server passes input data received from a thin client to the various programs including the operating system and operating on the corresponding virtual machine.

For example, if n thin clients are installed in a department (where staff members perform operations utilizing a common group of programs), the thin-client server normally manages, as a master, disk image data from a disk with the common group of programs (including the operating system) installed therein. Then, based on the master, the thin-client server, for example, creates n disk image data by customizing, for each thin client (or each user), individual information retained by the operating system and the like. On the n virtual machines to which the respective n thin clients installed in the department are assigned (and which are constructed on the thin-client server), the customized disk image data is used to start the various programs including the operating system.

For example, when the thin-client server creates a plurality of disk image data customized for the thin clients based on the master, many data accesses take place. Various mechanisms for improving the efficiency of such data accesses have been proposed.

In creating disk image data managed as the master, the illustrated thin-client server, for example, constructs a virtual machine for creation of the disk image data and installs the various programs including the operating system on the virtual machine. During the installation, for example, individual information for a supervisor such as machine names and IDs (Identification Data) is input. Thus, the various programs including the operating system retain the individual information for the supervisor. Hence, the thin-client server normally manages, as the master, the disk image data from which the supervisor's individual information retained by the various programs including the operating system has been deleted (initialization) (this disk image data is referred to as a master image) instead of managing the disk image data created during the installation without any change. As a result, disk image data (individual image) for each thin client (or each user) can be created simply by adding individual information for the thin client to the master image.

However, in this case, if, for example, the various programs including the operation system need to be upgraded or a new program needs to be added or any existing program needs to be changed or deleted, individual images (with which the various programs including the operating system retain the supervisor's individual information) only for this operation need to be recreated from the master image instead. On the other hand, managing the following two disk image data as a master without any change is not realistic because of, for example, the resulting need for twice the storage area based on simple calculations: the disk image data created during the installation and the disk image data from which the supervisor's individual information retained by the various programs including the operating system has been deleted.

Furthermore, in conventional techniques to improve the efficiency of data accesses, only a common cache provided in a physical disk driver or file system driver is utilized. Such a common cache is intended for caching for the whole physical disk. Thus, if, for example, another process involving an access to data other than the master image is being carried out in parallel, the cache hit ratio of data accesses taking place in a process of creating a plurality of individual images from the master image decreases significantly. Hence, there is a demand to construct a new cache system for more quickly carrying out particular processing including such accesses to the master image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a configuration of a network system to which an information processing apparatus according to an embodiment is applied.

FIG. 2 is an exemplary diagram schematically showing the system configuration of the information processing apparatus according to the embodiment.

FIG. 3 is an exemplary first diagram showing functional blocks related to a virtual machine system for the information processing apparatus according the embodiment.

FIG. 4 is an exemplary flowchart illustrating the entire flow of expansion of a master image carried out on the information processing apparatus according to the embodiment.

FIG. 5 is an exemplary second diagram showing the functional blocks related to the virtual machine system for the information processing apparatus according to the embodiment.

FIG. 6 is an exemplary third diagram showing the functional blocks related to the virtual machine system for the information processing apparatus according to the embodiment.

### DETAILED DESCRIPTION

Various embodiments will be described hereinafter with reference to the accompanying drawings.

In general, according to one embodiment, an information processing apparatus includes a virtual disk management module. The virtual disk management module is configured to manage a first virtual disk, a second virtual disk and a third virtual disk. The first virtual disk is a disk in which disk image data from a disk with various programs including an operating system installed therein is stored. The second virtual disk is a disk in which the disk image data stored in the first virtual disk and from which individual information retained by the various programs including the operating system has been deleted is stored. The second virtual disk is formed by combining the first virtual disk with a first difference that is a difference between the second virtual disk and the first virtual disk. The third virtual disk is a disk in which the disk image data stored in the second virtual disk and to which individual information to be retained by the various programs including the operating system has been added is stored. The third virtual disk is formed by combining the first virtual disk with the first difference and a second difference that is a difference between the third virtual disk and the second virtual disk.

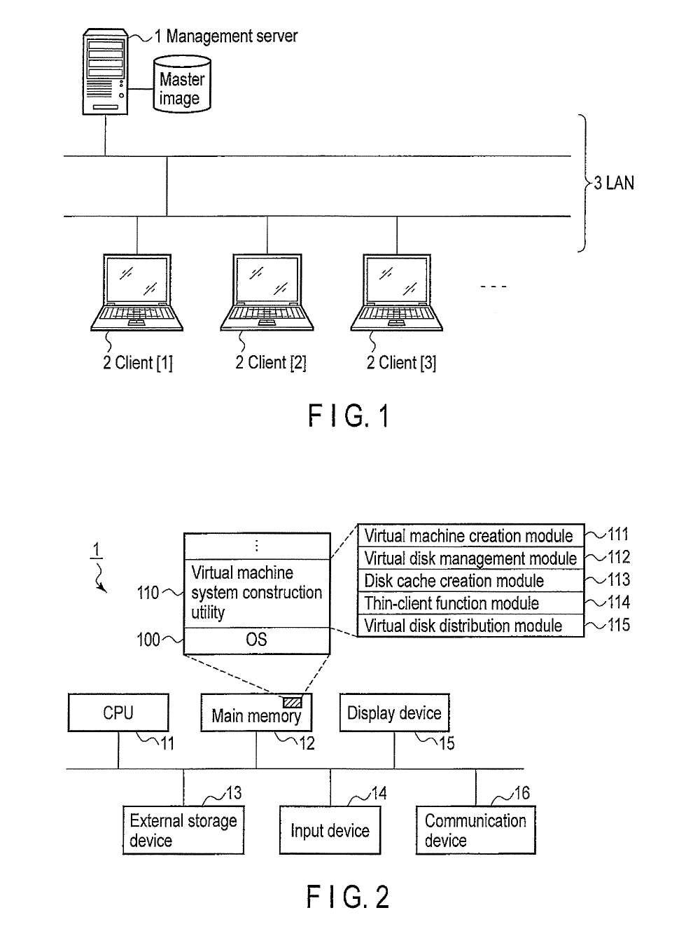

FIG. 1 is an exemplary diagram showing a configuration of a network system to which an information processing apparatus (management server 1) according to the present embodiment is applied. The network system is constructed for a business by a company. Employees (users) use respective clients 2 to perform operations. Software environments for the clients 2 are managed, in a unified manner, by a management server 1 connected to the clients 2 via LAN 3. More specifically, the management server 1 manages disk image data from disks in each of which various programs including an operating system used for operations by the corresponding user are installed. Each client 2 operates using disk image data managed by the management server 1.

Roughly two aspects are present in which each of the clients 2 operates using the disk image data managed by the management server 1.

(1) Thin Client

The management server 1 constructs a virtual machine for each client 2 thereon. The management server 1 uses the disk image data managed by the management server 1 to start the various programs including the operating system on each of the virtual machines. The virtual machine is a virtual hardware environment created by software and designed to operate the various programs including the operating system. The management server transmits display image data for a display screen created by the various programs including the operating system and operating on each virtual machine, to the corresponding client 2. The management server further passes input data received from the client 2 to the various programs including the operating system and operating on the corresponding virtual machine. The client 2 provides only a function to display display image data received from the management server on a display device and a function to transmit input data from a keyboard and the like to the management server 1.

(2) Rich Client

The management server 1 distributes the disk image data managed by the management server 1. Each client 2 stores the disk image data received from the management server 1 in, for example, an HDD (Hard Disk Drive). Each client 2 includes, for example, a virtualization engine (virtual machine monitor) installed therein which is software designed to allow a common PC comprising an HDD and the like to operate as a thin client. The virtualization engine is set to be a resident program. When the client 2 is powered on to start the operating system (hypervisor), the virtualization engine starts automatically under the control of the hypervisor. When started, the virtualization engine constructs a virtual machine on the client 2. The virtualization engine then uses the disk image data stored in, for example, the HDD to start the various programs including the operating system (guest OS) (various programs are included in the disk image data) on the constructed virtual machine.

The virtualization engine passes, to the hypervisor, display image data for a display screen created by the various programs including the guest OS and operating on the virtual machine to request the display image data to be displayed on the display device of the client 2. The virtualization engine further passes input data received from the hypervisor (and input via the keyboard and the like of the client 2) to the various programs including the guest OS and operating on the virtual machine. This operation of the virtualization engine allows the management server 1 to manage the software environments of the clients 2 in a unified manner.

Furthermore, user data used for the various programs operating on the virtual data is managed on the management server 1 (or a file server not shown in the drawings). When any of the various programs operating on the virtual machine generates a read request for user data, the virtualization engine acquires the user data from the management server 1 (or the file server not shown in the drawings) via LAN 3. On the other hand, when any of the various programs operating on the virtual machine generates a write request, the virtualization engine transmits the corresponding user data to the management server 1 (or the file server not shown in the drawings) via LAN 3. That is, no user data is stored in the client 2, allowing confidential information on the company to be prevented from leaking.

The aspect (2) is not intended to inhibit data from being stored on the client 2 side but can be adopted in order to reduce operation costs for a large number of the clients 2. For example, if a certain program is to be upgraded, costs can be reduced without the need to perform the upgrading operation for each client 2, by enabling the upgrading operation to be performed on the single master disk image data. If the main object is to reduce the costs, the virtualization engine need not necessarily provide a function to manage, on the management server 1 (or the file server not shown in the drawings) user data used for the various programs operating on the virtual machine.

Note that the management server 1 manages the disk image data common to the clients 2 as a master. The master disk image data (master image) is created by, for example, constructing a virtual machine for creation of the master image and installing the various programs including the guest OS on the virtual machine.

During the installation, for example, individual information for a supervisor such as machine names and IDs are input. Thus, the various programs including the operating system retain the individual information for the supervisor. Hence, the master image is customized so as to delete the individual information retained by the various programs including the guest OS (initialization). Disk image data (individual image) for each client 2 can be created by adding individual information for the client 2 to the master image.

In either of the aspects (1) and (2), the management server 1 needs to create an individual image for each client 2 as described above. The management server 1 according to the present embodiment is designed to, for example, speed up an operation of creating a plurality of individual images from the master image, while minimizing required storage areas. This will be described below. In the following description, the creation of a plurality of individual images based on one master image may be referred to as “expansion of the master image.”

FIG. 2 is an exemplary diagram schematically showing the system configuration of the information processing apparatus (management server 1) according to the present embodiment. As shown in FIG. 2, the management server 1 includes a CPU 11, a main memory 12, an external storage device 13, an input device 14, a display device 15, and a communication device 16.

The CPU 11 loads any of various programs including an operating system (OS) 100 from the external storage device 13 into the main memory 12 and executes the loaded programs. The various programs include a virtual machine system construction utility 110. The main memory 12 is a memory device serving as a main storage for the management server 1. On the other hand, the external storage device is a memory device serving as an auxiliary device for the main memory 12.

Furthermore, the input device 14 is designed for inputting for a user interface provided by the management server 1. On the other hand, the display device 15 is designed for outputting for the user interface provided by the management server 1. The communication device 16 communicates with the client 2 via LAN 3.

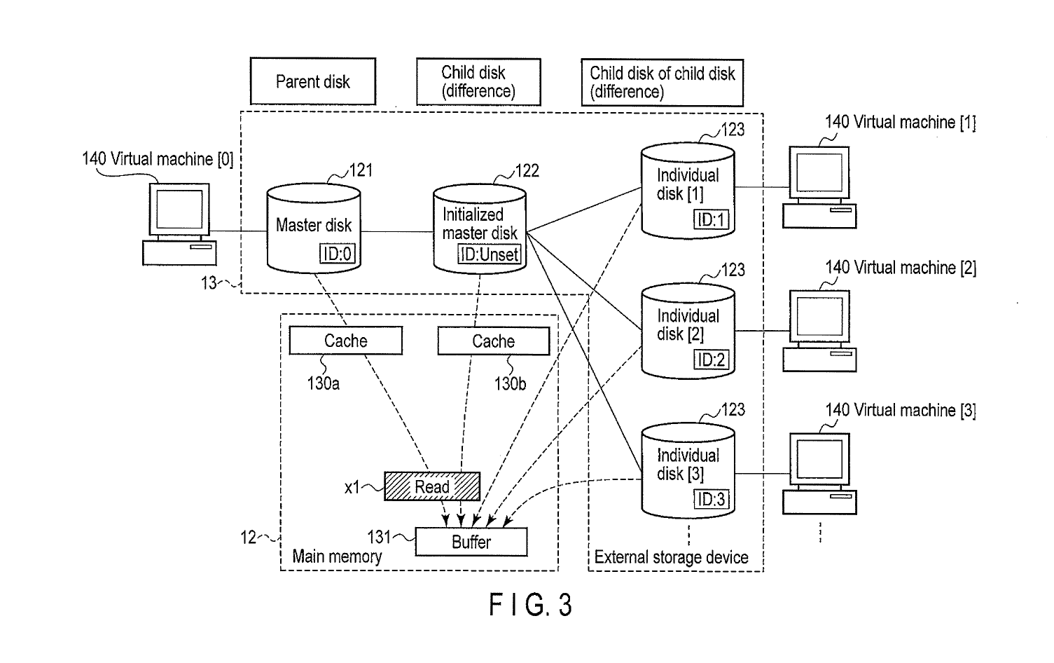

Now, a virtual machine system constructed by a virtual machine system construction utility 110 operating on the management server 1 will be described in brief with reference not only to FIG. 1 and FIG. 2 but also to FIG. 3. Here, the present network system is assumed to be constructed as what is called a thin-client system (above-described aspect (1)). FIG. 3 is an exemplary diagram showing functional blocks related to the virtual machine system for the management server 1.

As shown in FIG. 2, the virtual machine system construction utility 110 includes a virtual machine creation module 111, a virtual disk management module 112, a disk cache creation module 113, a thin-client function module 114, and a virtual disk distribution module 115.

The virtual machine creation module 111 is configured to create, in the management server, a virtual machine 140 that is a virtual hardware environment allowing the various programs including the operating system to operate. The virtual machine creation module 111 can create a plurality of the virtual machines 140 in the management server 1. In FIG. 3, a virtual machine [0] 140 is created when a master disk 121 described below is created. On the other hand, the virtual machine [n: n=1, 2, 3, . . . ] 140 is created for each client [n] 2.

First, the virtual disk management module 112 is configured to use the virtual machine [0] 140 created by the virtual machine creation module 111 to create a master disk 121 and to manage the created master disk 121. The virtual disk management module 112 creates the master disk 121 by installing, on the virtual machine [0] 140, the various programs including the guest OS used by the user of the client 2. That is, the master disk 121 is disk image data from a disk in which the various programs including the guest OS used by the user of the client 2 are installed. The master disk 121 is created as a virtual disk. In the virtual disk scheme, a partial area on a physical disk (external storage device 13, for example, HDD) is virtually used as one disk. The virtual disk management module 112 supports the virtual disk scheme.

While the virtual machine creation module 111 is carrying out the installation (on the virtual machine [0] 140), the supervisor inputs individual information machine names and IDs. The individual information is retained by the various programs including the guest OS and thus contained in the master disk 121 (“ID:0” in FIG. 3). Thus, the supervisor performs an operation of deleting the individual information contained in the master disk 121 (initialization).

Second, the virtual disk management module 112 is configured to create an initialized master disk 122 corresponding to the master disk 121 from which the individual information has been deleted (initialization) and to manage the created initialized master disk 122. Only the following is stored in the initialized master disk 122 created by the virtual disk management module 112: substantively, the difference between the master disk 122 containing the individual information and the master disk 121 from which the individual information has been deleted, specifically, patch data required to write an area in the master disk 121 to which the individual information has been written, back to initial values. That is, here, it is assumed that the virtual disk scheme supported by the virtual disk management module 112 provides a differential disk function. The differential may be either in file units or in sector units.

In other words, the master disk 121 and the initialized master disk 122 are in a parent disk-child disk relationship. The initialized master disk 122 is combined with the master disk 121 to form one virtual disk. More specifically, the initialized master disk 122 is combined with the master disk 121 to form a virtual disk corresponding to the master disk 121 from which the individual information has been deleted (initialization: “ID: unset” in FIG. 3).

Third, the virtual disk management module 112 is configured to create an individual disk 123 for each client 2 corresponding to the initialized master disk 122 to which the individual information (“ID: n” in FIG. 3) for each client 2 (or each user) has been added and to manage each of the created individual disks 123. Only the following is stored in each individual disk 123 created by the virtual disk management module 112: substantively, the difference between the initialized master disk 122 to which no individual information has been added and the initialized master disk 122 to which the individual information has been added, specifically, patch data required to write individual information to an area in the master disk 122. Thus, the master disk 121, the initialized master disk 122 and the individual disk 123 are in a parent disk-child disk-child disk of child disk relationship. The individual disk 123 is combined with the master disk 121 and the initialized master disk 122 to form one virtual disk.

In the illustrated example, the virtual disk management module 112 manages all of the master disk 121, the initialized master disk 122, and the individual disk 123. However, a management module may be provided individually for each of the master disk 121, the initialized master disk 122, and the individual disk 123.

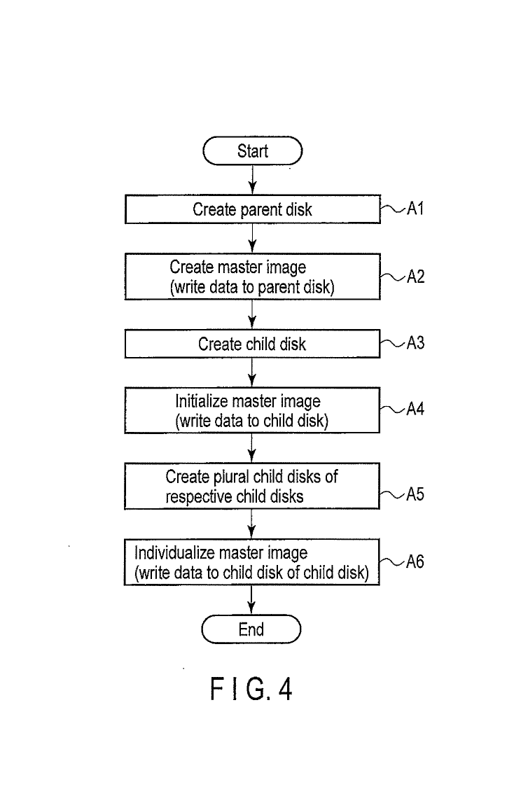

FIG. 4 is an exemplary flowchart illustrating the entire flow of expansion of master image carried out on the management server 1 according to the present embodiment.

First, the virtual disk management module 112 reserves an area for a master disk on a physical disk to create a parent disk (block A1). Subsequently, the virtual disk management module 112 uses the virtual machine [0] 140 created by the virtual machine creation module 111 to perform operations such as installation and setting of the guest OS and application programs on the parent disk, thus creating a master image (block A2).

Then, the virtual disk management module 112 reserves an area for a child disk on the physical disk to create a child disk (block A3). Subsequently, the virtual disk management module 112 initializes the master image and writes the results of the initialization to the child disk (block A4).

Finally, the virtual disk management module 112 reserves an area for a child disk of the child disk on the physical disk for each client 2 to create a plurality of child disks of the corresponding child disks (block A5). Then, the virtual disk management module 112 individualizes the master images for each client 2 and writes the results of the individualization to each child disk of the child disk (block A6).

In the aspect (1) described above, the individual disks 123 created and managed by the virtual disk management module 112 are assigned to the respective virtual machines [n] 140 created by the virtual machine creation module 111. The various programs including the guest OS (and contained in the individual disk [n] 123) are each started on the virtual machine [n] 140. The thin-client function module 114 is configured to transmit, to the client [n] 2, display image data for the display screen created by the various programs including the guest OS and operating on the virtual machine [n] 140 and to pass input data received from the client [n] 2 to the various programs including the guest OS and operating on the virtual machine [n] 140. That is, the thin-client function module 114 is configured to allow the management server 1 to operate as a thin-client server.

On the other hand, in the aspect (2) described above, the individual disk [n] 123 managed by the virtual disk management module 112 is distributed to the client [n] 2. Specifically, the distribution of the individual disk [n] 123 corresponds to the distribution of the master disk 121 the initialized master disk 122 the individual disk [n] 123. The virtual disk distribution module 115 is configured to distribute the individual disk 123 to the client 2.

As described above, in the management server 1 according to the present embodiment, the virtual disk management module 112 configured to support the virtual disk scheme with the differential disk function manages the master disk 121 as a parent disk, the initialized master disk 122 as a child disk, and the individual disk [n] 123 as a child disk of a child disk.

In the initialized master disk 122 that is a child disk, only the difference between the initialized master disk 122 and the master disk 121, which is a parent disk, is stored. In the individual disk [n] 123, which is a child disk of a child disk, only the difference between the individual disk [n] 123 and the initialized master disk 122, which is a child disk, is stored. Thus, even with increased number of clients 2 with software environments to be managed in a unified manner, the difference from the initialized master disk 122, that is, the individual information to be added to the initialized master disk 122, may be managed as the individual disk 123. That is, the management server 1 according to the present embodiment utilizes the virtual disk scheme with the differential disk function to obtain a three-step differential disk configuration with the master disk 121, the initialized master disk 122, and the individual disk 123. This enables an increase in disk efficiency and minimizes the required storage area. As a result, costs can be reduced.

Furthermore, the following is possible when the master disk 121 in which the various programs including the guest OS retains the supervisor's individual information manages the master disk 121 as a parent disk. That is, if the need arises to upgrade any of the various programs including the guest OS or to perform a maintenance operation such as addition, change, or deletion of any program, the master disk 121 can be used to perform the maintenance operation on the virtual machine [0] 140 as quickly as possible. Namely, the need to recreate an individual image for the maintenance operation from the initialized master disk 122 otherwise managed as the master is eliminated. This improves operational efficiency, further reducing costs.

Here, by way of example, the three-step differential disk configuration with the master disk 121, the initialized master disk 122, and the individual disk 123 has been described. However, a two-step differential disk configuration may be used as follows. An uninitialized master image avoids being managed as a parent disk. The results of initialization are written to a parent disk, and this initialized disk is used as a parent disk. An individual disk with the results of individualization written thereto is used as a child disk.

Now, a cache system will be described which is constructed by the management server 1 according to the present embodiment in order to speed up particular processing including accesses to the master image.

As described above, the individual disk 123 is combined with the master disk 121 and the initialized master disk 122 to form one virtual disk. Thus, in the aspect (1) assumed herein and described above, the virtual machine [n] 140 reads data from the master disk 121, which is a common parent disk, or the initialized master disk, which is a common child disk. Hence, the management server 1 according to the present embodiment is designed to create caches 130a and 130b on the main memory 12; when data is read from the master disk 121, the data read from the master disk 121 is stored in the cache 130a, and when data is read from the initialized master disk 122 (x1 in FIG. 3), the data read from the initialized master disk 122 is stored in the cache 130b, as shown in FIG. 3. The disk cache creation module 113 is configured to create the caches 130a and 130b.

If data read from the master disk 121 or the initialized master disk 122 by one virtual machine [n] 140 is stored in the cache 130a or 130b, the other virtual machines [n] 140 can read data quickly from the master disk 121 or the initialized master disk 122 (for example, when the various programs including the guest OS are started on the virtual machine [n] 140).

Whereas a common cache provided in a physical disk driver or a file system driver is intended for caching for the whole physical disk (external storage device 13, for example, HOD), the caches 130a and 130b are intended for caching for a partial area on the physical disk reserved for the master disk 121 (parent disk) and the initialized master disk 122 (child disk), which are virtual disks. Thus, the hit ratio of the cache is very high in connection with data reads from the master disk 121 (parent disk) or the initialized master disk 122 (child disk). Therefore, (when designed to create the cache 130a for the master disk 121 and the cache 130b for the initialized master disk 122 on the main memory 12) the virtual machine [n] 140 can quickly read data from the virtual disk.

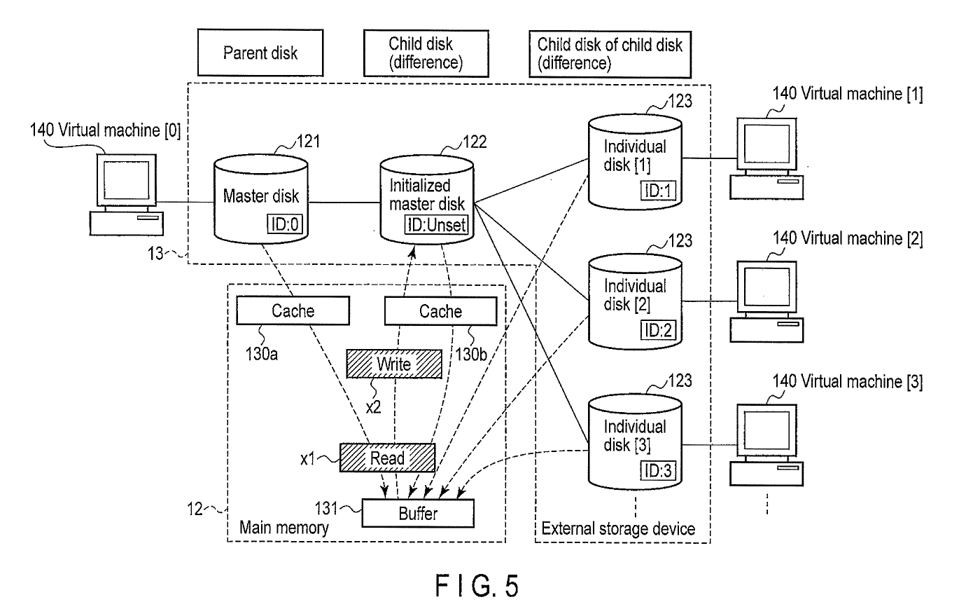

Furthermore, the cache 130b for the initialized master disk 122 is effective not only for storing data read from the virtual machine [n] 140 therein but also for storing write data (x2 in FIG. 5) to the initialized master disk 122 therein as shown in FIG. 5. Specifically, when the master disk 121 is initialized, that is, when the initialized master disk 122 is created, the virtual disk management module 112 saves data to be written to the initialized master disk 122, to the cache 130b.

For example, if the need arises to upgrade any of the various programs including the guest OS or to perform a maintenance operation such as addition, change, or deletion of any program and all the individual disks 123 thus need to be recreated, new individual disks 123 can be created by individualizing the master image for each client 2 using the initialized master disk 122. In this case, when the first individual disk 123 is created, that is, when the first data read is carried out on the initialized master disk 122, the data can also be read from the cache 130b. This allows reads to be further sped up. Additionally, when the virtual disk management module 112 creates the initialized master disk 122, the corresponding data is read from the master disk 121 and the read data is stored in the cache 130a. When the first individual disk 123 is created, the corresponding data can be read from the master disk 121 using the cache 130a.

Furthermore, the disk cache creation module 113 may create the caches 130a and 130b on the main memory exclusively when the virtual disk management module 112 creates the initialized master disk 122 or the individual disk 123. That is, the caches 130a and 130b are created only if the data to be accessed is estimated to be significantly locally present. This allows the usage of the main memory 12 to be appropriately suppressed.

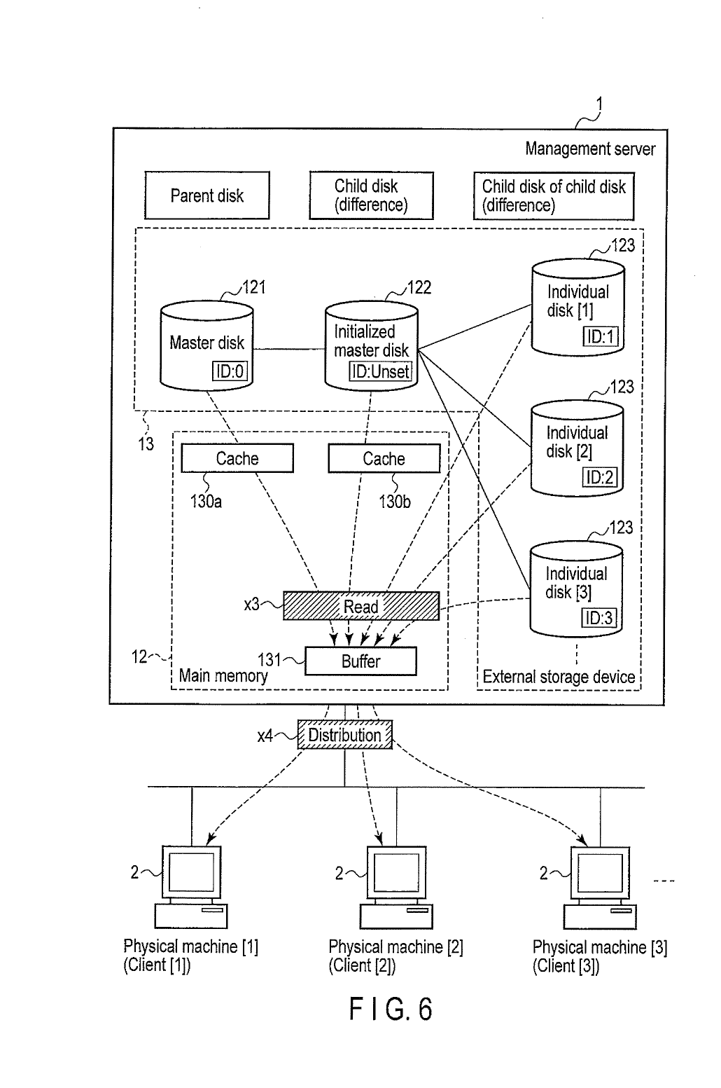

Now, the case where the present network system assumes the aspect (2) will be discussed with reference to FIG. 6. In this case, as described above, the virtual disk distribution module 115 distributes the individual disk 123 to each client 2. Furthermore, as described above, the individual disk 123 is combined with the master disk 121 and the initialized master disk 122 to form one virtual disk. Thus, the virtual disk distribution module 115 distributes the master disk 121, the initialized master disk 122, and the individual disk 123 to the client 2.

That is, when the virtual disk distribution module 115 distributes the individual disk 123 to each client 2 (x4 in FIG. 6), the distribution involves, in addition to data reads from the individual disk 123, many data reads from the master disk 121 and initialized master disk 122 common to the individual disks 123 (x3 in FIG. 6). Hence, when the cache 130a for the master disk 121 and the cache 130b for the initialized master disk 122 are created on the main memory 12, data reads from the master disk 121 and the initialized master disk 122 can be sped up. Furthermore, in order to appropriately inhibit the usage of the main memory 12, the disk cache creation module 113 may create the caches 130a and 130b exclusively when the virtual disk distribution module 115 distributes the individual disk 123 to each client 2.

As described above, first, the management server 1 according to the present embodiment utilizes the virtual disk scheme with the differential disk function and has the three-step differential disk configuration with the master disk 121, the initialized master disk 122, and the individual disk 123. Second, the management server 1 according to the present embodiment is designed to create the dedicated caches 130a and 130b for the master disk 121 and the initialized master disk 122, respectively, on the main memory 12. Thus, the present embodiment can, for example, speed up the operation of creating a plurality of individual images from a master image, while minimizing the required storage area.

Additionally, the operation control processing according to the present embodiment can be implemented by software (program). Hence, effects similar to those of the present embodiment can be easily produced by installing software in a normal computer through a computer readable storage medium with the software stored therein and then running the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a virtual disk management module configured to manage a first virtual disk, a second virtual disk and a third virtual disk, wherein:
the first virtual disk is a disk in which disk image data from a disk with various programs comprising an operating system installed therein is stored;
the second virtual disk is a disk in which the disk image data stored in the first virtual disk and from which individual information retained by the various programs comprising the operating system has been deleted is stored, the second virtual disk being formed by combining the first virtual disk with a first difference that is a difference between the second virtual disk and the first virtual disk; and
the third virtual disk is a disk in which the disk image data stored in the second virtual disk and to which individual information to be retained by the various programs comprising the operating system has been added is stored, the third virtual disk being formed by combining the first virtual disk with the first difference and a second difference that is a difference between the third virtual disk and the second virtual disk.

2. The apparatus of claim 1, further comprising a cache creation module configured to reserve, on a main memory, a cache area in which at least one of data from the first virtual disk and data from the second virtual disk is stored.

3. The apparatus of claim 2, wherein:
the first difference comprises data written to the disk with the various programs comprising the operating system installed therein in order to delete the individual information retained by the various programs comprising the operating system; and
the virtual disk management module is configured to store the first difference in the cache area when the second virtual disk is created.

4. The apparatus of claim 2, wherein the cache creation module is configured to reserve the cache area on the main memory when the virtual disk management module creates the second virtual disk or the third virtual disk.

5. The apparatus of claim 2, further comprising a virtual disk distribution module configured to distribute the third virtual disk comprising the first virtual disk, the first difference, and the second difference, to another information processing apparatus connected via a network.

6. The apparatus of claim 5, wherein the cache creation module is configured to reserve the cache area on the main memory when the virtual disk distribution module distributes the third virtual disk.

7. A computer-readable, non-transitory storage medium having stored thereon a computer program which is executable by a computer, the computer program controlling the computer to execute a function of managing a first virtual disk, a second virtual disk and a third virtual disk, wherein:
the first virtual disk is a disk in which disk image data from a disk with various programs comprising an operating system installed therein is stored;
the second virtual disk is a disk in which the disk image data stored in the first virtual disk and from which individual information retained by the various programs including the operating system has been deleted is stored, the second virtual disk being formed by combining the first virtual disk with a first difference that is a difference between the second virtual disk and the first virtual disk; and
the third virtual disk is a disk in which the disk image data stored in the second virtual disk and to which individual information to be retained by the various programs including the operating system has been added is stored, the third virtual disk being formed by combining the first virtual disk with the first difference and a second difference that is a difference between the third virtual disk and the second virtual disk.

8. The medium of claim 7, the computer program further controlling the computer to execute a function of reserving, on a main memory, a cache area in which at least one of data from the first virtual disk and data from the second virtual disk is stored.

9. The medium of claim 8, wherein:
the first difference comprises data written to the disk with the various programs comprising the operating system installed therein in order to delete the individual information retained by the various programs comprising the operating system; and
the managing comprises storing the first difference in the cache area when the second virtual disk is created.

10. The medium of claim 8, wherein the reserving comprises reserving the cache area on the main memory when the second virtual disk or the third virtual disk is created.

11. The medium of claim 8, the computer program further controlling the computer to execute a function of distributing the third virtual disk comprising the first virtual disk, the first difference, and the second difference, to another information processing apparatus connected via a network.

12. The medium of claim 11, wherein the reserving comprises reserving the cache area on the main memory when the third virtual disk is distributed.
